(19) United States
(12) Patent Application Publication
(10) Pub. No.: US 2026/0236142 A1
(43) Pub. Date: Aug. 13, 2026

(54) COMMUNICATION APPARATUS, CONTROL METHOD, AND STORAGE MEDIUM

(71) Applicant: CANON KABUSHIKI KAISHA, Tokyo (JP)

(72) Inventor: KENTA WATANABE, Kanagawa (JP)

(21) Appl. No.: 19/464,342

(22) Filed: Jan. 29, 2026

(30) Foreign Application Priority Data
Feb. 7, 2025 (JP) 2025-019592

(51) Int. Cl. G06F 3/0482; G06F 3/04845

(52) U.S. Cl. CPC G06F 3/0482; G06F 3/04845

(57) ABSTRACT

A communication apparatus that communicates with an external device, the communication apparatus includes a processor, and a memory storing a program which, when executed by the processor, causes the communication apparatus to perform processing of acquiring a plurality of first images from the external device, perform processing of displaying the plurality of first images on a list screen, and perform control processing of, in a case where a first operation is performed by a user on any of the plurality of first images on the list screen, adding operation information to the first image, and in a case where a second operation is performed by the user on the first image subjected to the first operation, clearing the operation information added to the first image, wherein the control processing includes storing in a storage unit image information about the first image to which the operation information is added.

### BACKGROUND

### Field of the Technology

The present disclosure relates to a communication apparatus, a control method, and a storage medium.

### Description of the Related Art

In recent years, there have been known imaging devices having a communication function. There is a system that causes, for example, an imaging device and an information processing device, such as a communication apparatus, to communicate with each other to display images recorded in the imaging device as a list on a display screen of the communication apparatus, and stores a selected image in the communication apparatus. Further, in recent years, memory media to be mounted on imaging devices have also increased in capacity, resulting in a tendency toward significant increase in the number of images that can be captured by the imaging devices.

In such a situation, there are cases where, after a large number of images are captured, an imaging device and a communication apparatus are caused to communicate with each other to display images in a list on a display screen of the communication apparatus, and images to be stored in the communication apparatus are selected. At this time, an efficient transfer method is required, such as reducing battery consumption in both the imaging device and the communication apparatus during the communication.

For example, Japanese Patent Application No. 2014-255346 describes a method in which, when a list of images stored in the imaging device is displayed on a display screen of the communication apparatus, an icon indicating that an image has already been stored in the communication apparatus is displayed for the corresponding images, preventing duplicate storage.

However, in the above-described conventional technique, if the communication apparatus is inadvertently disconnected from the imaging device during a selection operation, all of the information about the images that have already been selected is lost, and a user is forced to start the selection of images over.

### SUMMARY

According to an aspect of the present disclosure, a communication apparatus that communicates with an external device, the communication apparatus includes a processor, and a memory storing a program which, when executed by the processor, causes the communication apparatus to perform processing of acquiring a plurality of first images from the external device, perform processing of displaying the plurality of first images on a list screen, and perform control processing of, in a case where a first operation is performed by a user on any of the plurality of first images on the list screen, adding operation information to the first image, and in a case where a second operation is performed by the user on the first image subjected to the first operation, clearing the operation information added to the first image, wherein the control processing includes storing in a storage unit image information about the first image to which the operation information is added.

Features of the present disclosure will become apparent from the following description of embodiments with reference to the attached drawings. The following description of embodiments is described by way of example.

### BRIEF DESCRIPTION OF THE DRAWINGS

FIG. 1A is a block diagram illustrating a configuration of an imaging device according to a first embodiment of the present disclosure. FIGS. 1B and 1C illustrate an example of an appearance of the imaging device.

FIG. 2 is a block diagram illustrating a configuration of a communication apparatus according to the first embodiment of the present disclosure.

FIGS. 3A to 3C are general system diagrams illustrating a use case according to the first embodiment of the present disclosure.

FIG. 4 is a sequence diagram illustrating a communication between the communication apparatus and the imaging device according to the first embodiment of the present disclosure.

FIGS. 5A and 5B are flowcharts illustrating operations of the communication apparatus according to the first embodiment of the present disclosure.

FIG. 6 illustrates an example of a selection list according to the first embodiment of the present disclosure.

FIGS. 7A to 7F illustrate display examples of the communication apparatus according to the embodiments of the present disclosure.

FIGS. 8A and 8B are flowcharts illustrating operations of a communication apparatus according to a second embodiment of the present disclosure.

FIG. 9 illustrates an example of an editing list according to the second embodiment of the present disclosure.

### DESCRIPTION OF THE EMBODIMENTS

Some embodiments for implementing the present disclosure will now be described in detail with reference to the accompanying drawings.

The embodiments described below are merely examples of methods for implementing the present disclosure, and may be modified or changed as appropriate depending on the configuration of an apparatus to which the present disclosure is applied and various conditions. Further, the respective embodiments can also be combined as appropriate.

### First Embodiment

### Configuration of Imaging Device

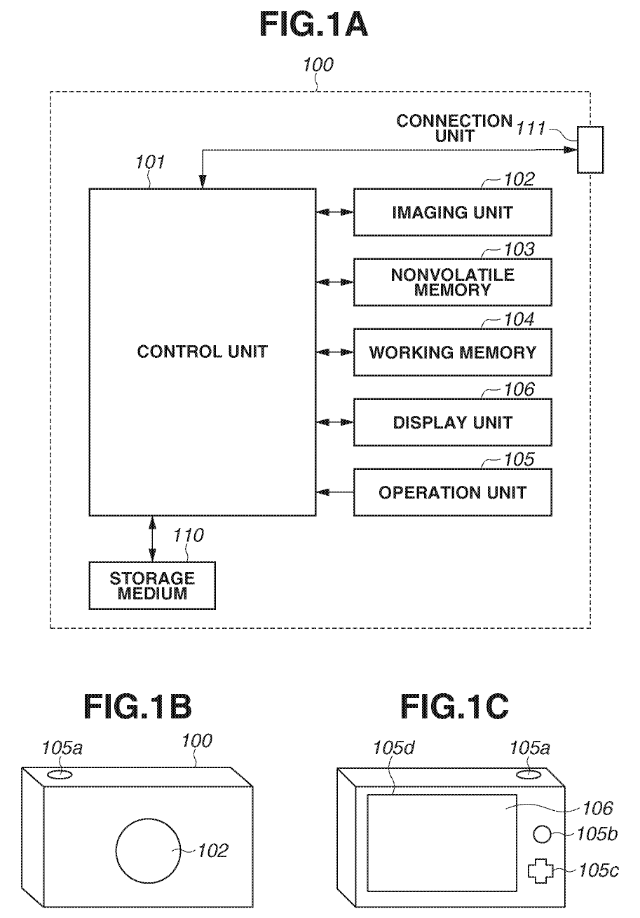

FIG. 1A is a block diagram illustrating a configuration example of an imaging device 100, which is an example of a communication apparatus according to a first embodiment. In the present embodiment, an imaging device will be described as an example of the communication apparatus, but the communication apparatus is not limited thereto. The communication apparatus may be, for example, an information processing device, such as a portable media player, a so-called tablet device, or a personal computer.

A control unit 101 controls each unit of the imaging device 100 based on an input signal and a program described below. A plurality of pieces of hardware may control the entire apparatus by sharing processing, instead of the control unit 101 controlling the entire apparatus.

An imaging unit 102 includes, for example, an optical system that controls an optical lens unit, a diaphragm, zoom, focus, and the like, and an image sensor for converting light (a video image) guided via the optical lens unit into an electric video signal. Generally, a Complementary Metal Oxide Semiconductor (CMOS) or a Charge

Coupled Device (CCD) is used as the image sensor. Under control of the control unit 101, the imaging unit 102 converts subject light imaged by a lens included in the imaging unit 102 into an electric signal using the image sensor, performs noise reduction processing and the like, and then outputs digital data as image data. The imaging device 100 according to the present embodiment records the image data in a storage medium 110 in compliance with the Design Rule for Camera File system (DCF) standards.

A nonvolatile memory 103, which is an electrically erasable and recordable nonvolatile memory, stores, for example, the below-described program performed by the control unit 101.

A working memory 104 is used as a buffer memory that temporarily holds image data captured by the imaging unit 102, an image display memory of a display unit 106, a working area of the control unit 101, and the like.

An operation unit 105 is used to receive instructions issued by a user to the imaging device 100. The operation unit 105 includes, for example, a power button with which the user instructs the imaging device 100 to turn the power on and off, a release switch used to instruct the imaging device 100 to capture an image, and a playback button used to instruct the imaging device 100 to play back image data. The operation unit 105 further includes an operation member, such as a dedicated connection button used to start communication with an external device via a connection unit 111, which will be described below. Further, the operation unit 105 also includes a touch panel provided on the display unit 106, which will be described below. The release switch includes an SW1 and an SW2. When the release switch is brought into a so-called half-pressed state, the SW1 is turned on. In this manner, instructions to start imaging preparations, such as autofocus (AF) processing, auto exposure (AE) processing, auto white balance (AWB) processing, and electronic flash (EF) (pre-flash emission) processing, are received. Further, when the release switch is brought into a so-called full-pressed state, the SW2 is turned on. In this manner, an instruction to capture an image is received.

The display unit 106, for example, displays a viewfinder image during imaging, captured image data, and text for an interactive operation. The imaging device 100 does not necessarily include the display unit 106 built therein. The display unit 106 may be provided in any manner as long as the imaging device 100 is connectible to the internal or external display unit 106 and has at least a display control function of controlling display on the display unit 106.

The storage medium 110 can record the image data output from the imaging unit 102.

The storage medium 110 may be configured to be detachably attachable to the imaging device 100 or may be built in the imaging device 100. In other words, the storage medium 110 may be provided in any manner as long as the imaging device 100 has at least a configuration to access the storage medium 110.

The connection unit 111 is an interface for connecting to an external device. The imaging device 100 according to the present embodiment can exchange data with the external device via the connection unit 111. For example, the image data generated by the imaging unit 102 can be transmitted to the external device via the connection unit 111. In the present embodiment, the connection unit 111 includes an interface for communicating with the external device via a so-called wireless local area network (LAN) in compliance with the Institute of Electrical and Electronics Engineers (IEEE) 802.11 standards.

The control unit 101 performs the wireless communication with the external device by controlling the connection unit 111. The communication method is not limited to the wireless LAN, and includes, for example, an infrared communication method. The connection unit 111 is an example of a first wireless communication unit.

The connection unit 111 of the imaging device 100 according to the present embodiment has access point (AP) mode serving as an access point in infrastructure mode, and client (CL) mode serving as a client in infrastructure mode. Then, the imaging device 100 according to the present embodiment can operate as a CL device in infrastructure mode by the connection unit 111 operating in CL mode. When the imaging device 100 operates as the CL device, connecting to a nearby AP device allows the imaging device 100 to participate in a network constructed by the AP device. Further, the imaging device 100 according to the present embodiment can also operate as a simple AP (hereinafter, referred to as a simple AP), which is one type of AP but is further limited in functionality, by the connection unit 111 operating in AP mode. When the imaging device 100 operates as the simple AP, the imaging device 100 constructs a network by itself. Devices positioned around the imaging device 100 can determine the imaging device 100 to be an AP device and participate in the network constructed by the imaging device 100. It is on the assumption that a program for causing the imaging device 100 to operate in the above-described manner is stored in the nonvolatile memory 103.

The imaging device 100 according to the present embodiment is a simple AP, which is one type of AP but lacks a gateway function for transferring data received from a CL device to an Internet provider or the like. Thus, even when receiving data from another device participating in the network constructed by itself, the imaging device 100 cannot transfer the data to a network, such as the Internet.

An appearance of the imaging device 100 will now be described. FIGS. 1B and 1C illustrate an example of the appearance of the imaging device 100. A release switch 105a, a playback button 105b, arrow keys 105c, and a touch panel 105d are operation members included in the above-described operation unit 105. Further, an image captured by the imaging unit 102 is displayed on the display unit 106.

The imaging device 100 has been described above.

### Internal Configuration of Communication Apparatus 200

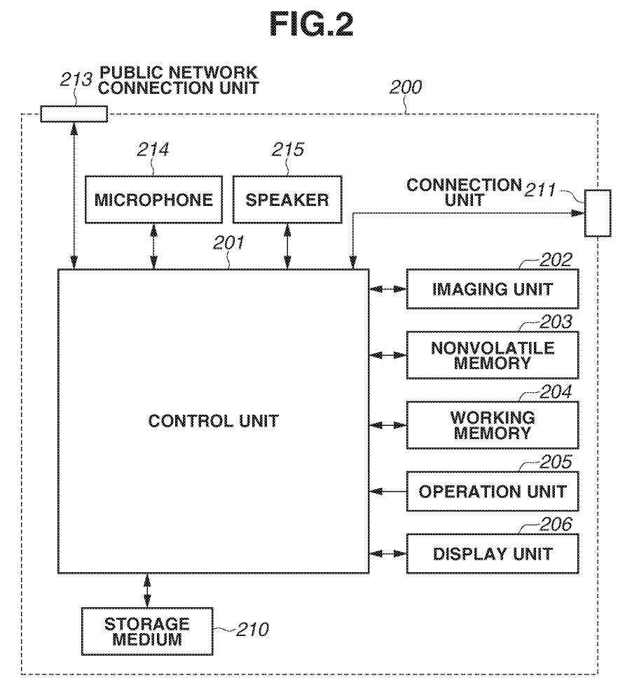

FIG. 2 is a block diagram illustrating an example of a configuration of a communication apparatus 200, which is an example of an information processing apparatus according to the present embodiment. In the present embodiment, a communication apparatus will be described as an example of the information processing apparatus, but the information processing apparatus is not limited thereto. The information processing apparatus may be, for example, an imaging device having a wireless function, a tablet device, or a personal computer.

A control unit 201 controls each unit of the communication apparatus 200 based on an input signal and a program described below. A plurality of pieces of hardware may control the entire apparatus by sharing processing, instead of the control unit 201 controlling the entire apparatus.

An imaging unit 202 converts subject light imaged by a lens included in the imaging unit 202 into an electric signal, performs noise reduction processing and the like, and then outputs digital data as image data. After being stored in a buffer memory, the captured image data is subjected to a predetermined calculation at the control unit 201 to be recorded in a storage medium 210.

A nonvolatile memory 203 is an electrically erasable and recordable nonvolatile memory. The nonvolatile memory 203 records an operating system (OS), which is basic software executed by the control unit 201, and an application for carrying out an advanced function in coordination with this OS. Further, in the present embodiment, the nonvolatile memory 203 stores an application for communicating with the imaging device 100.

A working memory 204 is used as an image display memory of the display unit 206, a working area of the control unit 201, and the like.

An operation unit 205 is used to receive instructions for the communication apparatus 200 from the user. The operation unit 205 includes, for example, operation members, such as a power button with which the user instructs the communication apparatus 200 to turn the power on and off, and a touch panel formed on the display unit 206.

The display unit 206, for example, displays image data and text for an interactive operation. The communication apparatus 200 does not necessarily include the display unit 206. The display unit 206 may be provided in any manner as long as the communication apparatus 200 is connectible to the display unit 206 and has at least a display control function of controlling display on the display unit 206.

The storage medium 210 can record the image data output from the imaging unit 202.

The storage medium 210 may be configured to be detachably attachable to the communication apparatus 200 or may be built in the communication apparatus 200. In other words, the storage medium 210 may be provided in any manner as long as the communication apparatus 200 has at least a configuration to access the storage medium 210.

The connection unit 211 is an interface for connecting to an external device. The communication apparatus 200 according to the present embodiment can exchange data with the imaging device 100 via the connection unit 211. In the present embodiment, the connection unit 211 is an antenna, via which the control unit 201 can connect to the imaging device 100. The connection to the imaging device 100 may be established via direct connection or an access point. For example, Picture Transfer Protocol over Internet Protocol (PTP/IP) via a wireless LAN can be used as a protocol for communicating data. However, the communication with the imaging device 100 is not limited thereto.

For example, the connection unit 211 can include a wireless communication module, such as an infrared communication module, a Bluetooth® communication module, or Wireless Universal Serial Bus (USB). Further, wired connections conforming to standards, such as USB, High-Definition Multimedia Interface (HDMI®), or IEEE 1394, may be also employed.

A public network connection unit 213 is an interface used when public wireless communication is performed.

The communication apparatus 200 allows the user to talk on the phone with another device via the public network connection unit 213. At this time, the control unit 201 enables the talk on the phone by inputting and outputting audio signals via a microphone 214 and a speaker 215, respectively. In the present embodiment, the public network connection unit 213 is an antenna, via which the control unit 201 can connect to the public network. The connection unit 211 and the public network connection unit 213 can also share a single antenna.

The communication apparatus 200 has been described above.

### Use Case

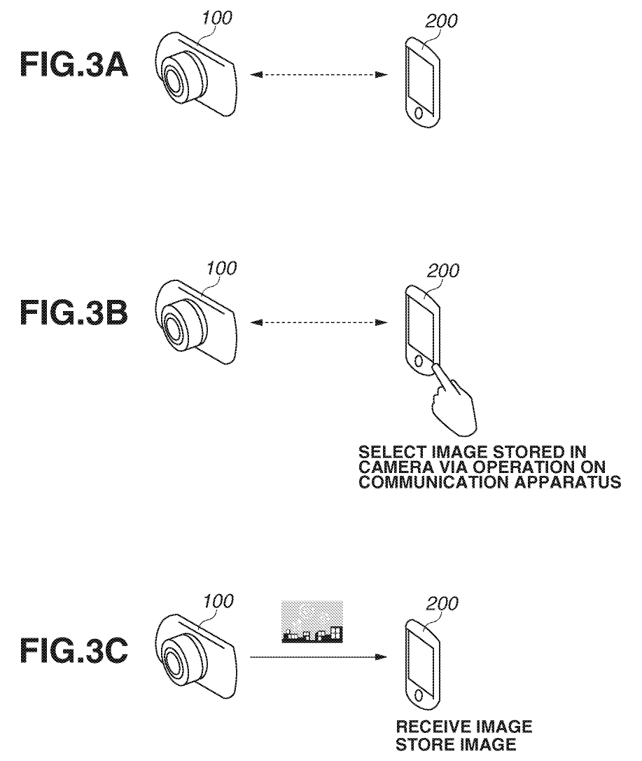

Subsequently, a use case in the first embodiment will be described. FIGS. 3A to 3C illustrate the use case in which the user connects the imaging device 100 and the communication apparatus 200, selects an image captured by the imaging device 100 on the communication apparatus 200, and transfers the selected image to the communication apparatus 200.

First, as illustrated in FIG. 3A, the imaging device 100 and the communication apparatus 200 establish a connection therebetween via the respective connection units based on the user's operation.

Next, as illustrated in FIG. 3B, the user selects an image to be stored in the communication apparatus 200 from a list of images stored in the imaging device 100, which is displayed on the communication apparatus 200.

Then, lastly, as illustrated in FIG. 3C, the imaging device 100 transfers the selected image to the communication apparatus 200 by the user issuing an instruction to start the transfer.

As described above, in the first embodiment, the use case is that the user operates the communication apparatus 200 to select an image to transfer while viewing images stored in the imaging device 100, which are displayed on the communication apparatus 200, and an operation of receiving the image is performed.

### Processing Sequence between Imaging Device 100 and Communication Apparatus 200

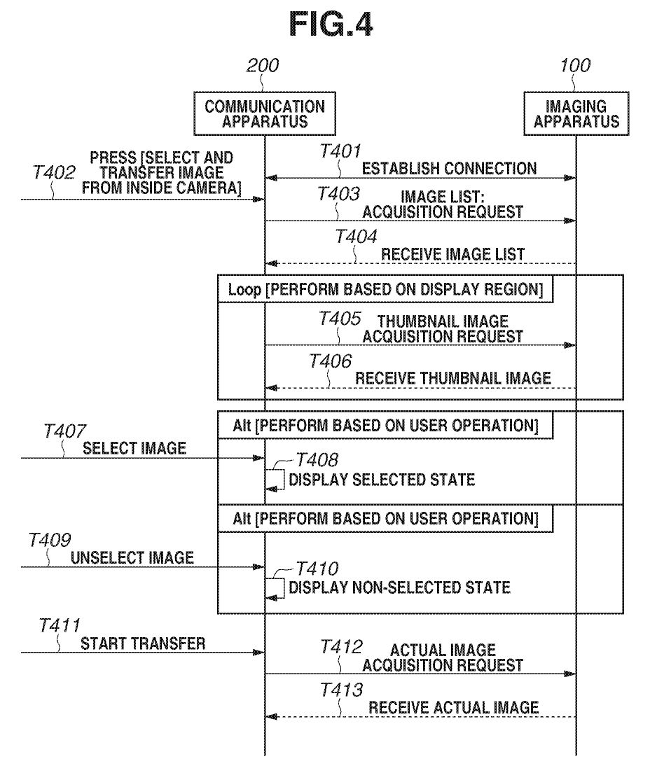

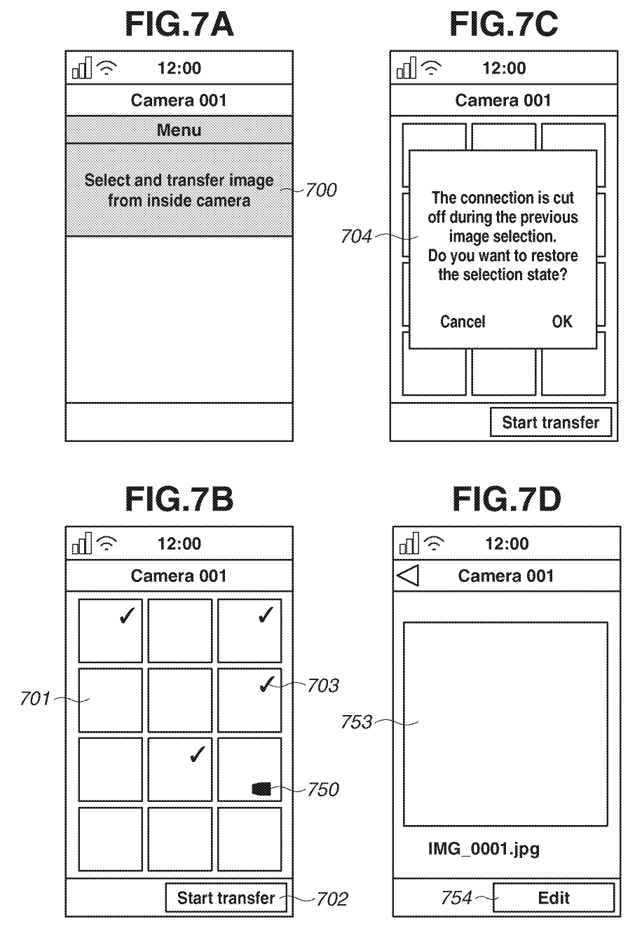

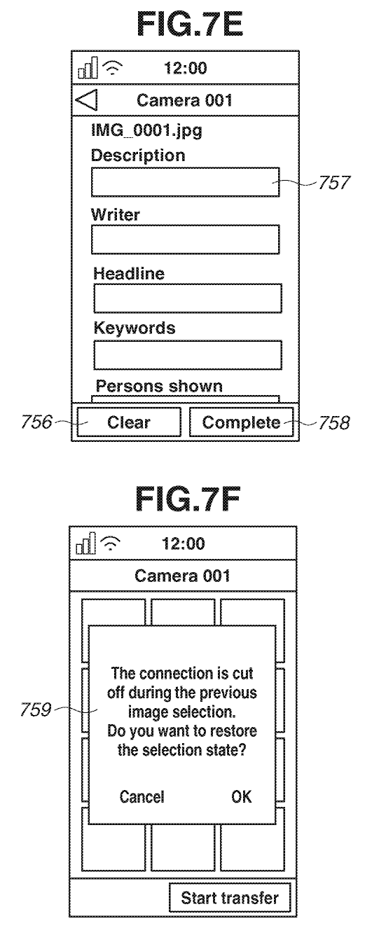

Processing in which an image recorded by the imaging device 100 is selected on and acquired by the communication apparatus 200 will now be described with reference to a sequence diagram illustrated in FIG. 4 and display screen views of the communication apparatus 200 illustrated in FIGS. 7A, 7B, and 7C.

In step T401, the communication apparatus 200 and the imaging device 100 establish a connection therebetween. At this time, such a screen as illustrated in FIG. 7A is displayed on the display unit 206 of the communication apparatus 200.

In step T402, the user presses a "select and transfer image from inside camera" button 700.

In step T403, the communication apparatus 200 transmits a request to acquire an image list to the imaging device 100 via the connection unit 211.

In step T404, the communication apparatus 200 receives the image list from the imaging device 100 via the connection unit 211. The image list here refers to a list including image identifiers (IDs) held in the recording unit of the imaging device 100.

In steps T405 and T406, based on the image list received in step T404, a thumbnail image list screen (hereinafter referred to as thumbnail image list display) is displayed on which thumbnail images, such as a thumbnail 701 illustrated in FIG. 7B are arranged in a tiled manner in the display region of the display unit 206, and thus, processing is repeatedly performed based on the display region. The display region is moved by the user's scroll operation of the display unit 206.

In step T405, the communication apparatus 200 transmits a request to acquire a thumbnail image to the imaging device 100 via the connection unit 211.

In step T406, the communication apparatus 200 receives the thumbnail image from the imaging device 100 via the connection unit 211. A thumbnail image is an example of a reference image of which the data size is smaller than that of the corresponding original image. Further, Exchangeable Image File Format (Exif) information, such as a file name and a shooting date and time, is included in the thumbnail image.

Steps T407 and T409 are operations performed based on the user's tap operation.

Step T407 is an operation in which the user selects an unselected thumbnail image via a tap operation. This allows the tapped image to be set as a transfer target (also referred to as an acquisition target).

In step T408, in response to the tap operation in step T407, the communication apparatus 200 updates the tapped thumbnail image to the display for a selected state (i.e., operation information is added to the image). In this case, the display on the display unit 206 on the communication apparatus 200 is updated as indicated by a check mark 703 in FIG. 7B.

Step T409 is an operation in which the user selects a thumbnail image in the selected state via a tap operation.

In step T410, in response to the tap operation in step T409, the communication apparatus 200 updates the tapped thumbnail image to the display for an unselected state. At this time, the display on the display unit 206 on the communication apparatus 200 is updated as indicated by the thumbnail 701 without a check mark in FIG. 7B.

Step T411 is an operation in which the user taps a transfer start button 702 in FIG. 7B.

In step T412, the communication apparatus 200 transmits a request to acquire the original image to the imaging device 100 via the connection unit 211 in response to the tap operation in step T411.

In step T413, the communication apparatus 200 receives the original image from the imaging device 100 via the connection unit 211. The processing from steps T411 to T413 is an example of a transfer instruction.

As described above, the user operates the display unit 206 of the communication apparatus 200 to perform the selection operation while checking the thumbnail images of images stored in the imaging device 100. In this case, if the communication apparatus 200 is disconnected from the imaging device 100 during the selection operation, the selection operation performed by the user is canceled, and the user is forced to perform the selection operation again even if the reconnection is re-established.

Thus, the present embodiment is intended to enable the selection operation to be resumed in response to the reconnection from where the operation is interrupted even when the communication apparatus 200 is disconnected from the imaging device 100 while the user is performing the selection operation on the communication apparatus 200.

### Processing Procedure of Communication Apparatus

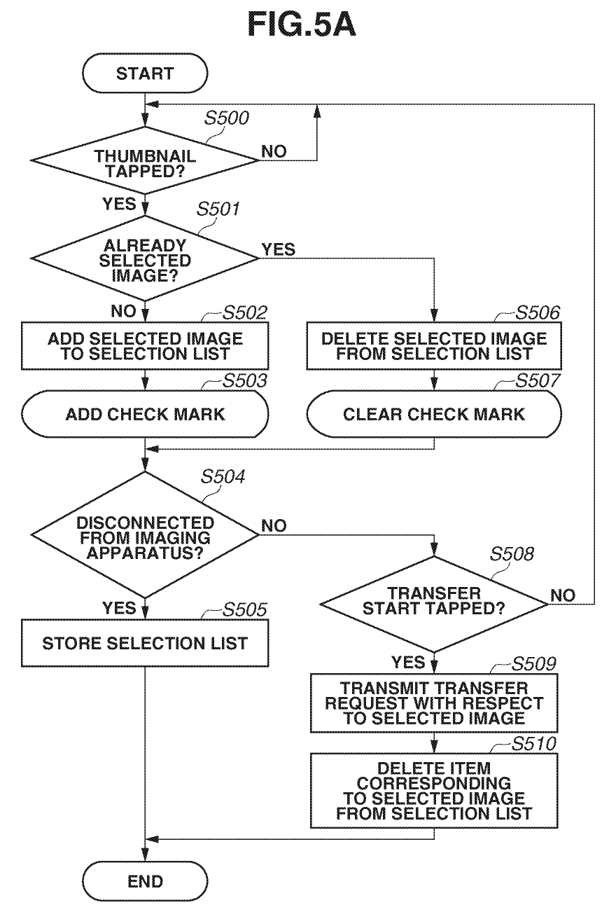

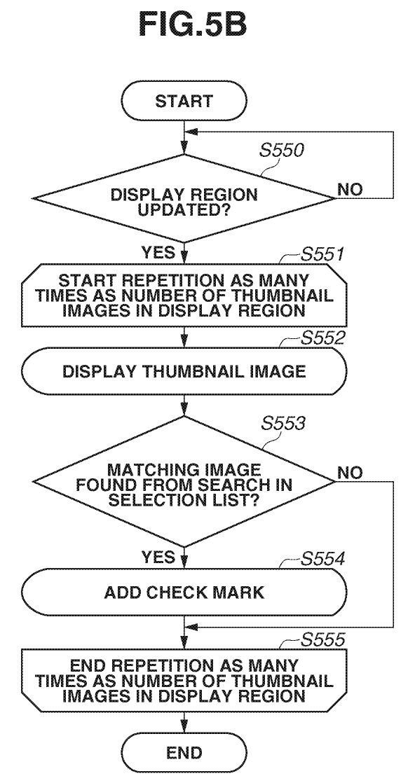

FIGS. 5A and 5B are flowcharts illustrating processing performed on the communication apparatus 200 to enable the selection operation to be resumed in response to the reconnection from where the operation is interrupted even when the communication apparatus 200 is disconnected from the imaging device 100 while the user is performing the selection operation.

FIG. 5A is a flowchart in a case where the communication apparatus 200 is initially connected to the imaging device 100. On the other hand, FIG. 5B is a flowchart in a case where the communication apparatus 200 is reconnected to the imaging device 100.

First, description will now be given with reference to FIG. 5A. The flowchart starts at a state in which the above-described processing in steps T405 and T406 is completed, and the thumbnail images are displayed on the display unit 206.

In step S500, the control unit 201 of the communication apparatus 200 determines whether a thumbnail image is tapped by the user. If the control unit 201 determines that a thumbnail image is tapped (YES in step S500), the processing proceeds to step S501. On the other hand, if the control unit 201 determines that a thumbnail image is not tapped (NO in step S500), the processing waits. The upper right position on the thumbnail 701 illustrated in FIG. 7B, i.e., the area around the check mark 703 is illustrated as an example of the range where the control unit 201 can determine whether the thumbnail image is tapped, but the range is not limited thereto. Any position on a thumbnail may be used as long as a tap by the user can be detected.

In step S501, the control unit 201 determines whether the image tapped in step S500 is a selected image. If the control unit 201 determines that the tapped image is a selected image (YES in step S501), the processing proceeds to step S506. On the other hand, if the control unit 201 determines that the tapped image is not a selected image (NO in step S501), the processing proceeds to step S502.

In step S502, the control unit 201 adds information about the selected image to a selection list. The selection list is stored in the working memory 204, but is newly created by the control unit 201 if the list does not exist.

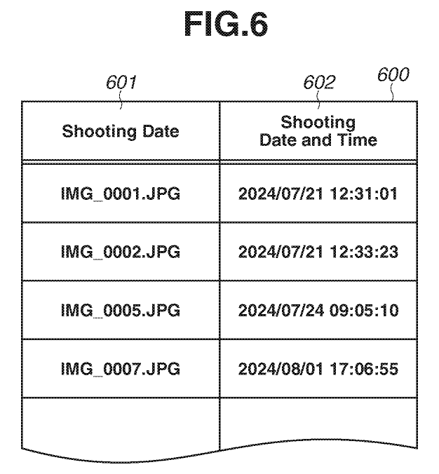

The selection list will now be described with reference to FIG. 6. A selection list 600 illustrated in FIG. 6 includes a pair of a file name 601 of an image and a shooting date and time 602 of the image. The shooting date and time is information acquired from the Exif attached to the image. Storing this combination as the selection list makes it possible for the communication apparatus 200 to store a selection state of the image.

The description returns to FIG. 5A. In step S503, the control unit 201 adds a check mark to be superimposed on the corresponding thumbnail image on the display unit 206 as indicated by the check mark 703 in FIG. 7B.

In step S504, the control unit 201 determines whether the communication apparatus 200 is disconnected from the imaging device 100. If the control unit 201 determines that the communication apparatus 200 is disconnected from the imaging device 100 (YES in step S504), the processing proceeds to step S505. On the other hand, if the control unit 201 determines that the communication apparatus 200 is not disconnected from the imaging device 100 (NO in step S504), the processing proceeds to step S508.

In step S505, the control unit 201 stores in the nonvolatile memory 203 the selection list stored in the working memory 204 in response to the disconnection from the imaging device 100, and then deletes the selection list stored in the working memory 204. When being stored, the selection list is stored under a predetermined file name so that the control unit 201 can refer to the selection list again.

In step S506, the control unit 201 refers to the selection list stored in the working memory 204 for information about the selected image to delete from the list an image whose information matches.

In step S507, the control unit 201 clears the check mark superimposed on the corresponding thumbnail image displayed on the display unit 206, changing the thumbnail display to that illustrated as the thumbnail 701 in FIG. 7B.

In step S508, the control unit 201 determines whether the transfer start button 702 illustrated in FIG. 7B is tapped by the user. If the control unit 201 determines that the transfer start button is tapped (YES in step S508), the processing proceeds to step S509. On the other hand, if the control unit 201 determines that the transfer start button is not tapped (NO in step S508), the processing returns to step S500.

In step S509, the control unit 201 transmits an image transfer request for the selected image to the imaging device 100 via the connection unit 211.

In step S510, the control unit 201 deletes the selected image requested to be transferred in step S509 from the selection list stored in the nonvolatile memory 203.

Next, description will be given with reference to FIG. 5B. The flowchart starts at the timing when the above-described processing in step T404 is completed with the communication apparatus 200 reconnected to the imaging device 100.

In step S550, the control unit 201 determines whether a display region displayed on the display unit 206 is updated. The update of the display region refers to a thumbnail image region that has not been displayed being caused to be displayed at the timing when the screen illustrated in FIG. 7A is switched to the screen illustrated in FIG. 7B, or by the user performing a swipe operation on the screen of the display unit 206 illustrated in FIG. 7B. If the control unit 201 determines that the display region is updated (YES in step S550), the processing proceeds to step S551.

On the other hand, if the control unit 201 determines that the display region is not updated (NO in step S550), the processing waits.

In step S551, the control unit 201 starts processing that repeats steps S552 to S554 as many times as the number of images displayed in the display region.

In step S552, the control unit 201 displays a thumbnail image. At this time, a check mark is not added to the thumbnail image as indicated by the thumbnail 701 in FIG. 7B.

In step S553, the control unit 201 refers to the selection list stored in the nonvolatile memory 203, and searches for matching content by comparing the file name and the shooting date and time regarding the thumbnail image displayed in step S552. If the control unit 201 determines that matching content exists (YES in step S553), the processing proceeds to step S554. On the other hand, if the control unit 201 determines that matching content does not exist (NO in step S553), the processing proceeds to step S555.

In step S554, the control unit 201 adds a check mark to be superimposed on the thumbnail image displayed in step S552. This allows the user to recognize that this image is already selected.

In step S555, the control unit 201 determines whether the processing of steps S552 to S554 is repeated as many times as the number of images displayed in the display region. If the control unit 201 determines that the repetition is completed, the processing ends. On the other hand, if the control unit 201 determines that the repetition is not completed, the processing returns to step S552.

As described above, with the selection list stored in the nonvolatile memory 203, even if the imaging device 100 is disconnected during a selection operation, the selection list is referred to upon reconnection, and the selection state is restored, which makes it possible to resume the selection operation.

In the present embodiment, regarding the timing of deleting the selected image from the selection list, the selected image is deleted immediately after the image transfer request is transmitted as described in step S510, but the timing is not limited thereto. For example, the selected image may be deleted at the timing when the transfer result is obtained in response to an issuance of an image transfer request. Even if the communication apparatus 200 is disconnected during image transfer, this allows the transfer request for an image that could not be transferred to be easily reissued upon reconnection.

Further, a condition that a predetermined time has elapsed may be added as the timing of deleting the selection list, in addition to the timing immediately after the image transfer request is transmitted. This makes it possible to avoid a stored selection list being continuously left.

Further, in step S505, the selection list is stored depending on the determination in step S504 as to whether the communication apparatus 200 is disconnected from the imaging device 100, but the storage of the selection list is not limited thereto. For example, in the case of an explicit disconnection due to an operation on the imaging device 100 or the communication apparatus 200 by the user, a determination is made that this disconnection is not an exceptional disconnection, and thus, the information may not be stored as the selection list.

Further, the flowchart illustrated in FIG. 5B starts at the timing when the above-described processing in step T404 is completed with the communication apparatus 200 is reconnected to the imaging device 100. However, at this timing, if the length of the selection list stored in the nonvolatile memory 203 of the communication apparatus 200 is one or more, a dialog 704 to inquire of the user whether to restore the selection state illustrated in FIG. 7C may be displayed on the display unit 206.

Further, while it has been described that the file name and the shooting date and time regarding a thumbnail image are stored as a pair in the selection list, the selection list is not limited thereto. For example, in addition to the file name and the shooting date and time, the serial number of the connected imaging device may be associated. This enables, when a plurality of imaging devices is taken into consideration, a selection list to be maintained for each imaging device, making it possible to avoid conflict in selection states.

### Second Embodiment

In the first embodiment, the example is described that allows the selection state to be restored when the imaging device 100 and the communication apparatus 200 are reconnected, by storing, when connection between the imaging device 100 and the communication apparatus 200 is disconnected, a selection list to which the user adds an image on the imaging device 100 at the timing when the user selects the image via the user's operation on the communication apparatus 200 connected to the imaging device 100.

In the present embodiment, an example will be described in which, when the connection is cut off while any image stored in the imaging device 100 is being edited on the communication apparatus 200, the editing state can be restored.

### Processing Procedure of Communication Apparatus

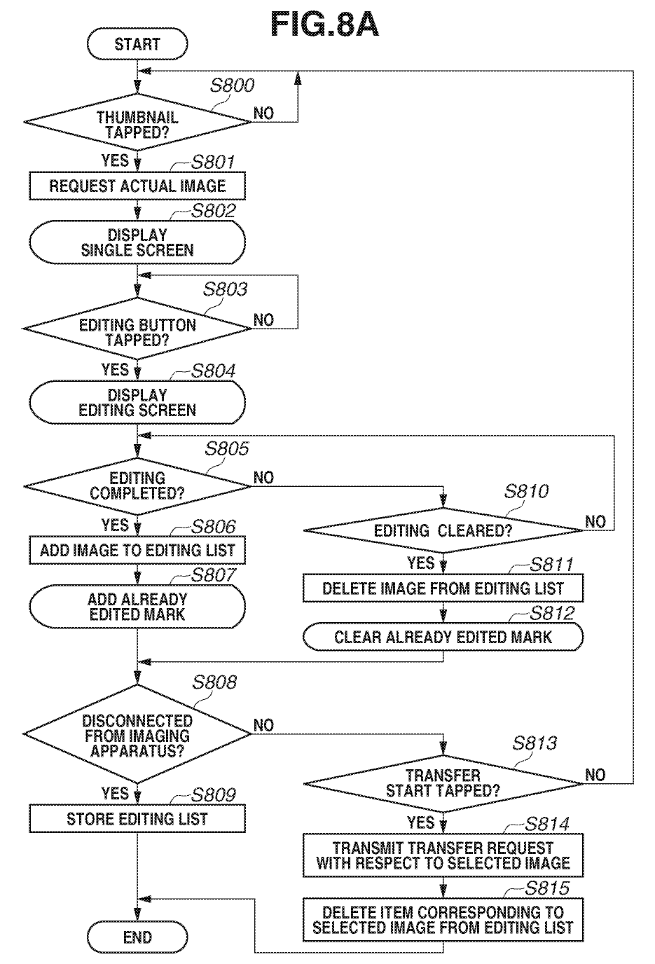

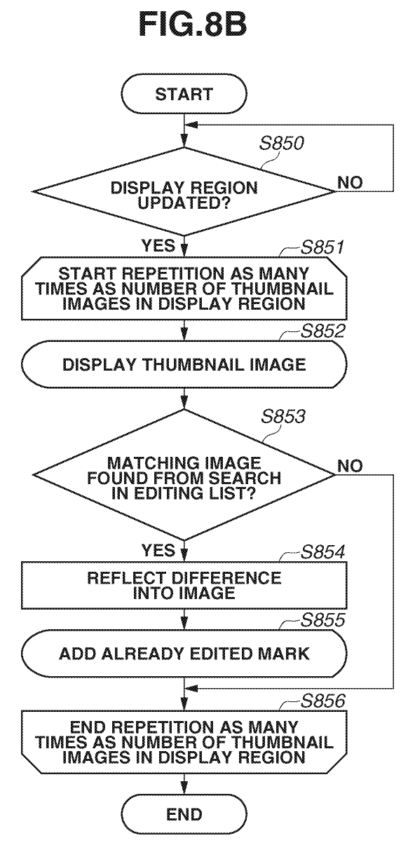

FIGS. 8A and 8B are flowcharts illustrating processing on the communication apparatus 200, which show that the editing operation can be resumed from where the operation is interrupted upon reconnection even when the communication apparatus 200 is disconnected from the imaging device 100 while the editing operation is being performed.

FIG. 8A is a flowchart in a case where the communication apparatus 200 is initially connected to the imaging device 100. On the other hand, FIG. 8B is a flowchart in a case where the communication apparatus 200 is reconnected to the imaging device 100.

First, description will be given with reference to FIG. 8A. The flowchart starts at a state in which the above-described processing in steps T405 and T406 is completed, the thumbnail images are displayed on the display unit 206, and a plurality of thumbnail images are selected (i.e., thumbnail images are displayed on the display unit 206 as illustrated in FIG. 7B).

In step S800, the control unit 201 of the communication apparatus 200 determines whether a thumbnail image is tapped by the user. If the control unit 201 determines that a thumbnail image is tapped (YES in step S800), the processing proceeds to step S801. On the other hand, if the control unit 201 determines that a thumbnail image is not tapped (NO in step S800), the processing waits.

In step S801, the control unit 201 requests the original image of the image tapped in step S800 from the imaging device 100 via the connection unit 211 to receive the original image.

In step S802, the control unit 201 displays the original image received in step S801 on the display unit 206. In this case, the original image is displayed in a display region 753 as illustrated in FIG. 7D.

In step S803, the control unit 201 determines whether an editing button 754 is tapped by the user. If the control unit 201 determines that the editing button 754 is tapped (YES in step S803), the processing proceeds to step S804. On the other hand, if the control unit 201 determines that the editing button 754 is not tapped (NO in step S803), the processing waits.

In step S804, the control unit 201 displays an image information editing screen illustrated in FIG. 7E on the display unit 206.

In step S805, the control unit 201 determines whether an edit is completed by the user. It is determined that an edit is completed by an editing completion button 758

being pressed as illustrated in FIG. 7E. If the control unit 201 determines that an edit is completed (YES in step S805), the processing proceeds to step S806. On the other hand, if the control unit 201 determines that an edit is not completed (NO in step S805), the processing proceeds to step S810.

In step S806, the control unit 201 adds information about the edited image to an editing list. The editing list is stored in the working memory 204, but is newly created by the control unit 201 if the list does not exist. Further, if an item whose file name and shooting date and time match is already added in the editing list, the matching item is updated.

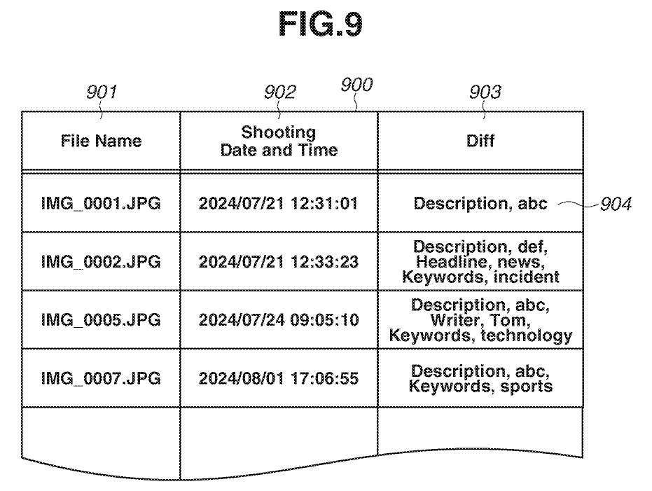

The editing list will now be described with reference to FIG. 9. An editing list 900 illustrated in FIG. 9 includes a set of a file name 901 of an image, a shooting date and time 902 of the image, and an editing difference 903. Regarding the editing difference 903, for example, when "abc" is input to an editing item 757 in FIG. 7E from a blank state, the item name and the editing content "abc" are stored while being separated by a comma as indicated by a cell 904.

The description returns to FIG. 8A. In step S807, the control unit 201 adds an edited mark to be superimposed on the corresponding thumbnail image on the display unit 206 as indicated by an edited mark 750 in FIG. 7B.

In step S808, the control unit 201 determines whether the communication apparatus 200 is disconnected from the imaging device 100. If the control unit 201 determines that the communication apparatus 200 is disconnected from the imaging device 100 (YES in step S808), the processing proceeds to step S809. On the other hand, if the control unit 201 determines that the communication apparatus 200 is not disconnected from the imaging device 100 (NO in step S808), the processing proceeds to step S813.

In step S809, the control unit 201 stores in the nonvolatile memory 203 the editing list stored in the working memory 204 in response to the disconnection from the imaging device 100, and then deletes the editing list stored in the working memory 204. When being stored, the editing list is stored under a predetermined file name so that the control unit 201 can refer to the editing list again.

In step S810, the control unit 201 determines whether the edit is cleared by the user. It is determined that the edit is cleared by a clear button 756 being pressed as illustrated in FIG. 7E. If the control unit 201 determines that the edit is cleared (YES in step S810), the processing proceeds to step S811. On the other hand, if the control unit 201 determines that the edit is not cleared (NO in step S810), the processing returns to step S805. The clear button 756 is enabled only when the user starts re-editing an edited image.

In step S811, the control unit 201 refers to the editing list stored in the working memory 204 for information about the edited image to delete from the list an item whose information matches.

In step S812, the control unit 201 clears the edited mark from the corresponding thumbnail image on the display unit 206 as indicated by the thumbnail 701 in FIG. 7B.

In step S813, the control unit 201 determines whether the transfer start button 702 illustrated in FIG. 7B is tapped by the user. If the control unit 201 determines that the transfer start is tapped (YES in step S813), the processing proceeds to step S814. On the other hand, if the control unit 201 determines that the transfer start button is not tapped (NO in step S813), the processing returns to step S800.

In step S814, the control unit 201 transmits an image transfer request for the selected image to the imaging device 100 via the connection unit 211.

In step S815, the control unit 201 deletes an item that matches the selected image that is requested to be transferred in step S814 from the editing list stored in the nonvolatile memory 203.

Next, description will be given with reference to FIG. 8B. The flowchart starts at a timing when the above-described processing in step T404 is completed with the communication apparatus 200 reconnected to the imaging device 100.

In step S850, the control unit 201 determines whether a display region displayed on the display unit 206 is updated. The update of the display region refers to a thumbnail image region that has not been displayed being caused to be displayed at the timing when the screen illustrated in FIG. 7A is switched to the screen illustrated in FIG. 7B, or by the user performing a swipe operation on the display unit 206. If the control unit 201 determines that the display region is updated (YES in step S850), the processing proceeds to step S851.

On the other hand, if the control unit 201 determines that the display region is not updated (NO in step S850), the processing waits.

In step S851, the control unit 201 starts processing that repeats steps S852 to S855 as many times as the number of images displayed in the display region.

In step S852, the control unit 201 displays a thumbnail image. At this time, an edited mark is not added to the thumbnail image as indicated by the thumbnail 701 in FIG. 7B.

In step S853, the control unit 201 refers to the editing list stored in the nonvolatile memory 203, and searches for content that matches the file name and the shooting date and time regarding the thumbnail image displayed in step S852. If the control unit 201 determines that matching content exists (YES in step S853), the processing proceeds to step S854. On the other hand, if the control unit 201 determines that matching content does not exist (NO in step S853), the processing proceeds to step S856.

In step S854, the control unit 201 reflects the difference in the target image. Specifically, the control unit 201 associates the content of the editing difference with the target image to be stored in the working memory 204. This allows the editing content to be reflected when the editing screen is displayed (step S804).

In step S855, the control unit 201 adds an edited mark to be superimposed on the thumbnail image displayed in step S852.

In step S856, the control unit 201 determines whether the processing of steps S852 to S855 is repeated as many times as the number of images displayed in the display region, and the processing ends if the control unit 201 determines that this repetition is completed. On the other hand, if the control unit 201 determines that this repetition is not completed, the processing returns to step S852.

As described above, with the editing list stored in the nonvolatile memory 203, even if the imaging device 100 is disconnected during an editing operation, the editing list is referred to upon reconnection, and the editing state of each image is restored, which makes it possible to resume the editing operation.

In the present embodiment, regarding the timing of deleting the selected image from the editing list, the selected image is deleted immediately after the image transfer request is transmitted as described in step S815, but the timing is not limited thereto.

Further, in step S809, the editing list is stored depending on the determination in step S808 as to whether the communication apparatus 200 is disconnected from the imaging device 100, but the storage of the editing list is not limited thereto. For example, in the case of an explicit disconnection due to an operation on the imaging device 100 or the communication apparatus 200 by the user, a determination is made that this disconnection is not an exceptional disconnection, and thus, the editing list may not be stored.

Further, a condition that a predetermined time has elapsed may be added as the timing of deleting the editing list, in addition to the timing immediately after the image transfer request is transmitted. This makes it possible to avoid a stored editing list being continuously left.

Further, the flowchart illustrated in FIG. 8B starts at a timing when the above-described processing in step T404 is completed with the communication apparatus 200 reconnected to the imaging device 100. However, at this timing, if the length of the editing list stored in the nonvolatile memory 203 of the communication apparatus 200 is one or more, a dialog 759 illustrated in FIG. 7F may be displayed on the display unit 206 to inquire of the user whether to restore the editing state.

Further, while it has been described that the file name and the shooting date and time regarding a thumbnail image are stored as a pair in the editing list, the editing list is not limited thereto. For example, in addition to the file name and the shooting date and time, the serial number of the connected imaging device may be associated. This enables, when a plurality of imaging devices is taken into consideration, an editing list to be maintained for each imaging device, making it possible to avoid conflict in editing states.

Further, in the present embodiment, the example is described of the image editing using the image information editing screen illustrated in FIG. 7E, but the image editing is not limited thereto. For example, the degree of tilt of an image, the editing of the tilt being as a target, may be stored as an angle value in association with the file name and the shooting date and time.

The embodiments of the present disclosure have been described above, but the present disclosure is not limited to the embodiments. Various modifications and changes can be made within the scope of the gist thereof.

### Other Embodiments

In the above-described embodiments, whether a file is a chunk recording file is determined using the file naming convention, but the determination is not limited thereto.

For example, whether a file is a chunk recording file may be determined based on information included in a metadata information file of moving image data.

The embodiments of the present disclosure have been described above, but the present disclosure is not limited to the embodiment. Various modifications and changes can be made within the scope of the gist thereof.

The present disclosure can also be implemented by performing the following processing. Specifically, the present disclosure can also be implemented by processing that supplies software (a program) for carrying out the functions of the above-described embodiments to a system or an apparatus via a network or various types of storage media, and causes a computer (or a control unit, a micro processing unit (MPU), or the like) of the system or the apparatus to read and execute the program code. In this case, the program and the storage media storing the program are included in the present disclosure.

The present disclosure has been described in detail based on the embodiments thereof, but the present disclosure is not limited to these specific embodiments. Various forms that do not depart from the gist of the present disclosure are also included in the present disclosure. The above-described embodiments may be partially combined as appropriate.

Each functional unit of each of the above-described embodiments (each modification) may be or may not be an individual separate piece of hardware. Functions of two or more functional units may be carried out by common hardware. Two or more functions of a single functional unit may be carried out by individual separate pieces of hardware. Two or more functions of a single functional unit may be carried out by common hardware. Further, each functional unit may be or may not be implemented as hardware, such as an Application Specific Integrated Circuit (ASIC), a field-programmable gate array (FPGA), or a digital signal processor (DSP). For example, the apparatus may include a processor and a memory (a storage medium) storing a control program. Then, a function of at least a part of the functional units included in the apparatus may be carried out by the processor reading the control program from the memory to execute the control program.

The present disclosure can also be implemented by processing that supplies a program capable of carrying out one or more functions of the above-described embodiments to a system or an apparatus via a network or a storage medium, and causes the one or more processors in a computer of the system or the apparatus to read and execute the program. Further, the present disclosure can also be implemented by a circuit (for example, an ASIC) capable of carrying out one or more functions.

### Configuration 1

A communication apparatus that communicates with an external device, the communication apparatus comprising:

an acquisition unit configured to acquire a plurality of first images from the external device;

a display unit configured to perform processing of displaying the plurality of first images on a list screen; and

a control unit configured to perform control processing of, in a case where a first operation is performed by a user on any of the plurality of first images on the list screen, adding operation information to the first image, and in a case where a second operation is performed by the user on the first image subjected to the first operation, clearing the operation information added to the first image,

wherein the control unit stores in a storage unit image information about the first image to which the operation information is added.

### Configuration 2

The communication apparatus according to configuration 1, wherein the acquisition unit acquires a second image corresponding to the first image to which the operation information is added in a case where a transfer instruction is issued from the user.

### Configuration 3

The communication apparatus according to configuration 2, wherein in a case where the second image is acquired, the control unit clears the operation information added to the first image corresponding to the second image and deletes the image information about the first image from the storage unit.

### Configuration 4

The communication apparatus according to any one of configurations 1 to 3, wherein the display unit displays the first image to which the operation information is added in such a manner that the addition of the operation information is distinguishable.

### Configuration 5

The communication apparatus according to configuration 4, wherein in a case where the plurality of first images is acquired by the acquisition unit, the control unit compares image information about each of the plurality of first images and the image information about the first image to which the operation information that is stored in the storage unit is added, and displays, in a case where image information about any one of the plurality of first images matches the image information about the first image to which the operation information that is stored in the storage unit is added, the matching first image in a distinguishable manner.

### Configuration 6

The communication apparatus according to any one of configurations 1 to 5

wherein the first operation is an operation to set a second image as an acquisition target from the plurality of first images displayed on the list screen, and

wherein the second operation is an operation to clear the first image subjected to the first operation from the acquisition target.

### Configuration 7

The communication apparatus according to configuration 6, wherein the second operation is the same as the first operation.

### Configuration 8

The communication apparatus according to configuration 2,

wherein the first operation is an operation to set the second image as an acquisition target from the plurality of first images displayed on the list screen, and

wherein the second operation is an operation to clear the first image subjected to the first operation from the acquisition target.

### Configuration 9

The communication apparatus according to any one of configurations 1 to 8, wherein the control unit stores the image information about the first image added to the operation information in the storage unit when the communication with the external device is cut off.

### Configuration 10

The communication apparatus according to configuration 1, wherein the first operation includes an operation of acquiring a second image corresponding to the first image and editing this second image.

### Configuration 11

The communication apparatus according to configuration 10, wherein the second operation includes an operation of undoing the editing performed on the second image.

### Configuration 12

The communication apparatus according to any one of configurations 1 to 11, wherein the second image is an image larger in data size than the first image.

### Method

A method for controlling a communication apparatus that communicates with an external device, the control method being executed by a processor, the control method comprising:

acquiring a plurality of first images from the external device;

displaying the plurality of first images on a list screen;

adding, in a case where a first operation is performed by a user on any of the plurality of first images on the list screen, operation information to the first image, and in a case where a second operation is performed by the user on the first image subjected to the first operation, clearing the operation information added to the first image; and

storing image information about the first image to which the operation information is added in a storage unit of the communication apparatus.

### Program

A program for causing a computer to function as each of the units of the communication apparatus according to configuration 1.

According to the present disclosure, even when the connection is cut off while an operation is being performed on an image stored in an imaging device, the operation can be easily resumed upon reconnection.

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-019592, filed Feb. 7, 2025, which is hereby incorporated by reference herein in its entirety.

What is claimed is:

1. A communication apparatus that communicates with an external device, the communication apparatus comprising:
a processor; and
a memory storing a program which, when executed by the processor, causes the communication apparatus to:
perform processing of acquiring a plurality of first images from the external device;
perform processing of displaying the plurality of first images on a list screen; and
perform control processing of, in a case where a first operation is performed by a user on any of the plurality of first images on the list screen, adding operation information to the first image, and in a case where a second operation is performed by the user on the first image subjected to the first operation, clearing the operation information added to the first image,
wherein the control processing includes storing in a storage unit image information about the first image to which the operation information is added.

2. The communication apparatus according to claim 1, wherein the processing of acquiring the plurality of first images includes acquiring a second image corresponding to the first image to which the operation information is added in a case where a transfer instruction is issued from the user.

3. The communication apparatus according to claim 2, wherein in a case where the second image is acquired, the control processing includes clearing the operation information added to the first image corresponding to the second image and deleting the image information about the first image from the storage unit.

4. The communication apparatus according to claim 1, wherein the processing of displaying on the list screen the plurality of first images includes displaying the first image to which the operation information is added in such a manner that the addition of the operation information is distinguishable.

5. The communication apparatus according to claim 4, wherein in a case where the plurality of first images is acquired by an acquisition unit, the control processing includes comparing image information about each of the plurality of first images and the image information about the first image to which the operation information that is stored in the storage unit is added, and displaying, in a case where image information about any one of the plurality of first images matches the image information about the first image to which the operation information that is stored in the storage unit is added, the matching first image in a distinguishable manner.

6. The communication apparatus according to claim 1,
wherein the first operation is an operation to set a second image as an acquisition target from the plurality of first images displayed on the list screen, and
wherein the second operation is an operation to clear the first image subjected to the first operation from the acquisition target.

7. The communication apparatus according to claim 6, wherein the second operation is the same as the first operation.

8. The communication apparatus according to claim 2,
wherein the first operation is an operation to set the second image as an acquisition target from the plurality of first images displayed on the list screen, and
wherein the second operation is an operation to clear the first image subjected to the first operation from the acquisition target.

9. The communication apparatus according to claim 1, wherein the control processing includes storing the image information about the first image added to the operation information in the storage unit when the communication with the external device is cut off.

10. The communication apparatus according to claim 1, wherein the first operation includes an operation of acquiring a second image corresponding to the first image to which the operation information is added and editing this second image.

11. The communication apparatus according to claim 10, wherein the second operation includes an operation of undoing the editing performed on the second image.

12. The communication apparatus according to claim 1, wherein the second image is an image larger in data size than the first image.

13. A method for controlling a communication apparatus that communicates with an external device, the control method being executed by a processor, the control method comprising:
acquiring a plurality of first images from the external device;
displaying the plurality of first images on a list screen;
adding, in a case where a first operation is performed by a user on any of the plurality of first images on the list screen, operation information to the first image, and in a case where a second operation is performed by the user on the first image subjected to the first operation, clearing the operation information added to the first image; and
storing image information about the first image to which the operation information is added in a storage unit of the communication apparatus.

14. A non-transitory computer readable storage medium that stores a program, wherein the program causes a computer to execute a method for controlling a communication apparatus that communicates with an external device, the method comprising:
acquiring a plurality of first images from the external device;
displaying the plurality of first images on a list screen;
adding, in a case where a first operation is performed by a user on any of the plurality of first images on the list screen, operation information to the first image, and in a case where a second operation is performed by the user on the first image subjected to the first operation, clearing the operation information added to the first image; and
storing image information about the first image to which the operation information is added in a storage unit of the communication apparatus.
